(19) United States
(12) Patent Application Publication
(10) Pub. No.: US 2009/0168459 A1
(43) Pub. Date: Jul. 2, 2009

(54) LIGHT GUIDE INCLUDING CONJUGATE FILM

(75) Inventors: Robert L. Holman, Evanston, IL (US); Matt Sampsell, Chicago, IL (US); Russell Wayne Gruhlke, Mulpitas, CA (US); Gang Xu, Cupertino, CA (US); Marek Mienko, San Jose, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM Incorporated, San Diego, CA (US)

(21) Appl. No.: 11/965,644

(22) Filed: Dec. 27, 2007

(51) Int. Cl. F21V 7/04; H01J 9/02

(52) U.S. Cl. 362/623; 445/24

(57) ABSTRACT

In various embodiments described herein, a front light guide panel comprises a plurality surface relief features having a variety of different sloping surface portions. Light injected into an edge of the light guide propagates though the light guide until it strikes one of the surface relief features. The light is then turned by total internal reflection such that the light is directed onto a reflective modulator array rearward of the light guide panel. The light reflects from the modulator array and is transmitted back through the surface features of the light guide panel. However, depending upon where the light is incident on the surface features, the light will be refracted at different angles by the different sloping surface portions. As a result, light reflected from a single point on the modulator array appears to originate from different locations, and ghost images appear. To reduce such ghosting, a conjugate film having equal and opposite surface relief features is disposed forward of the light guide panel. Light reflected from the modulator array and passing through surface relief features on the light guide panel is refracted a second time by the conjugate film to return the rays to their original trajectory.

### BACKGROUND

1. Field

The present invention relates to microelectromechanical systems (MEMS).

2. Description of the Related Art

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

Various embodiments described herein comprise light guides for distributing light across an array of display elements. The light guide may include surface relief features to turn light propagating in a light guide onto the array of display elements. The surface relief features may comprise facets that reflect light. In some embodiments, a contoured transmissive surface is disposed over the light guide. This contoured transmissive surface may protect the facets. Other embodiments are also disclosed.

One embodiment of the invention comprises an illumination apparatus comprising a light guide panel having a first end for receiving light from a light source, the light guide panel comprising material that supports propagation of the light along the length of the light guide panel. The illumination apparatus further comprises a plurality of indentations disposed on a first side of the light guide panel, the indentations are configured to turn at least a substantial portion of the light incident on the first side and to direct the portion of light out a second, opposite side of the light guide panel, the indentations having sloping sidewalls that reflect light by total internal reflection out the second side of the light guide panel and at least one contoured transmissive surface comprising a plurality of protruding surface portions having substantially complimentary shape to corresponding of the plurality of indentations in the light guide panel, the at least one contoured transmissive surface separated from the light guide panel by a gap.

The illumination apparatus disclosed above may further comprise a light bar disposed with respect to the light guide panel, wherein the light bar has a first end for receiving light from the light source, the light bar comprising material that supports propagation of the light along the length of the light bar. The light bar further comprises turning microstructure disposed on a first side of the light bar, the turning microstructure configured to turn at least a substantial portion of light incident on the first side and to direct the portion of the light out a second opposite side of the light bar. In some embodiments, at least one substantially reflective surface is disposed with respect to the light bar to reflect light escaping from the light bar through a portion of the light bar other than the second side back into the light bar.

Another embodiment of the invention comprises a method of manufacturing an illumination apparatus. In this method, a light guide panel is provided having a first end for receiving light from a light source. The light guide panel comprises material that supports propagation of the light along the length of the light guide panel. A plurality of indentations is disposed on a first side of the light guide panel. The indentations are configured to turn at least a substantial portion of the light incident on the first side and to direct the portion of light out a second, opposite side of the light guide panel. The indentations have sloping sidewalls that reflect light by total internal reflection out the second side of the light guide panel. At least one contoured transmissive surface is provided. The at least one contoured transmissive surface comprises a plurality of protruding surface portions having substantially complimentary shape to corresponding of the plurality of indentations in the light guide panel. The at least one contoured transmissive surface is separated from the light guide panel by a gap.

Another embodiment of the invention comprises an illumination apparatus. The illumination apparatus comprises means for guiding light having a means for receiving light from a means for emitting light. The light guiding means comprises means for supporting propagation of the light along the length of the light guiding means. The illumination apparatus further comprises means for turning at least a substantial portion of light incident on a first side of the light guiding means. The light turning means is configured to direct the portion of light out a second, opposite side of the light guiding means. The light turning means has means for reflecting light by total internal reflection out the second side of the light guiding means. The illumination apparatus additionally comprises means for transmitting light comprising means for providing a complimentary shape to corresponding of the light turning means in the light guiding means. The light transmitting means is separated from the light guide means by means for separating.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A is a schematic illustration of a cross section of a portion of a display device including a spatial light modulator array and a light guide panel.

FIG. 8B is schematic illustration of an expanded cross section of a portion of the display device of FIG. 8A illustrating formation of a ghost image.

FIG. 9A is schematic illustration of a cross section of a portion of another embodiment of a display device including a spatial light modulator array, a light guide panel, and a conjugate film.

FIG. 9B is schematic illustration of an expanded cross section of a portion of the display device of FIG. 9A.

FIG. 10 is schematic illustration of a perspective view of a portion of a display device including an illumination apparatus comprising a light emitter, a light bar, and a light guide panel.

FIG. 11A is schematic illustration of a cross section of a portion of another display device including an illumination apparatus comprising reflective surfaces disposed about a light bar.

FIG. 11B is schematic illustration of a top plan view of a portion of the display device of FIG. 11A.

FIG. 11C is schematic illustration of a close-up view of the reflective surface disposed with respect to the light bar which comprises turning features.

FIG. 11D is a schematic representation of a light bar including diffractive turning features and a reflective surface disposed with respect thereto.

FIG. 12A is schematic illustration of another cross section of a portion of the display device of FIG. 11A showing the intensity distribution of the light injected into the light guide panel.

FIG. 12B is schematic illustration of another top plan view of a portion of the display device of FIG. 11A also showing the intensity distribution of the light injected into the light guide panel.

FIG. 13A is schematic illustration of a cross section of a portion of another display device including a light bar with retro-reflector disposed above and below a light bar.

FIG. 13B is schematic illustration of a top plan view of a portion the display device of FIG. 13A showing the intensity distribution resulting from the retro-reflectors.

FIG. 14A is a schematic representation of a light bar including turning features having metallization disposed thereon.

FIG. 14B is a schematic representation of a light bar including turning features and a contoured reflector disposed with respect thereto.

FIG. 15A is schematic illustration of a cross-sectional view of an example embodiment of an illumination apparatus comprising a tapered light bar.

FIG. 15B is schematic illustration of a cross-sectional view of an example embodiment of an illumination apparatus that includes a tapered coupler between a light bar and a light guide panel.

### DETAILED DESCRIPTION OF THE PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In various embodiments described herein, the display may be edge lit from a linear light source such as a light bar or an array of LEDs disposed adjacent to a light guide panel. The light guide panel is disposed forward a reflective spatial light modulator array, such as an array of MEMs elements or other display elements. The front light guide panel may comprise a plurality surface relief features having a variety of different sloping surface portions. Light injected into an edge of the light guide propagates though the light guide until it strikes one of the surface relief features. The light is then turned by total internal reflection such that the light is directed onto the reflective modulator array rearward of the light guide panel. The light reflects from the modulator array and is transmitted back through the surface features of the light guide panel. However, depending upon where the light is incident on the surface features, the light will be refracted at different angles by the different sloping surface portions. As a result, light reflected from a single point on the modulator array appears to originate from different locations, and one or more ghost images appear. To reduce such ghosting, a conjugate film having generally equal and opposite surface relief features is disposed forward of the light guide panel. Light rays reflected from the modulator array and passing through surface relief features on the light guide panel are refracted a second time by the conjugate film to redirect the light rays onto a trajectory similar to the direction of the light rays within the light guide panel.

In certain embodiments, the reflective spatial light modulator array comprises display elements arranged in rows and columns. In some embodiments, the display elements comprise MEMS devices. In various embodiments, the display elements comprise interferometric modulators.

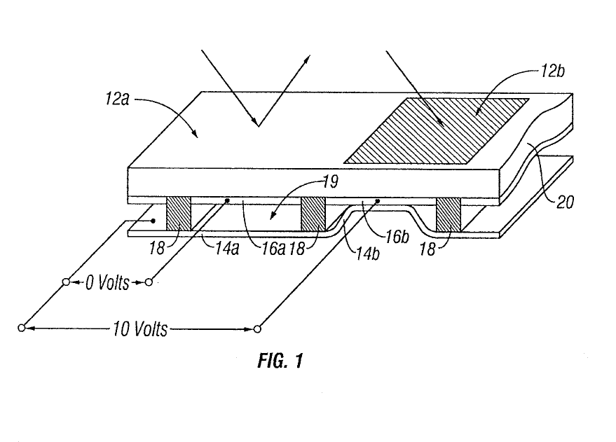

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

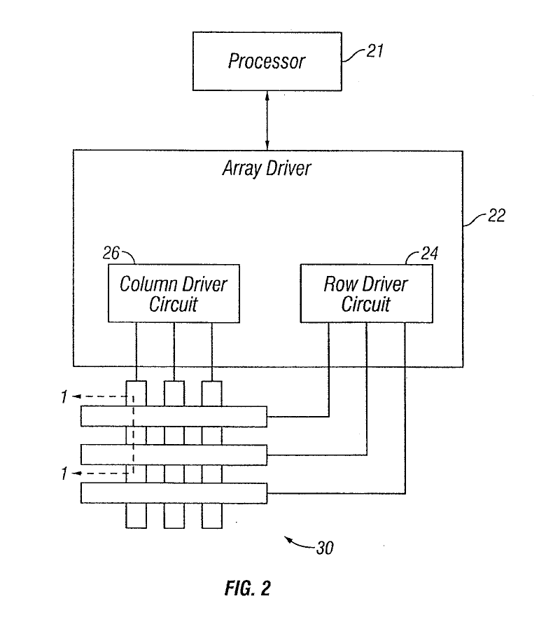

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

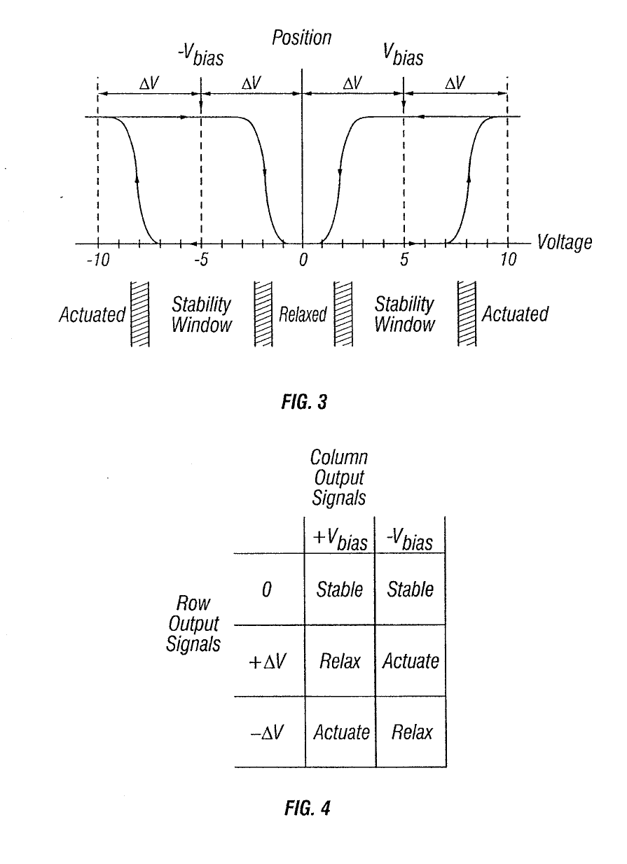

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

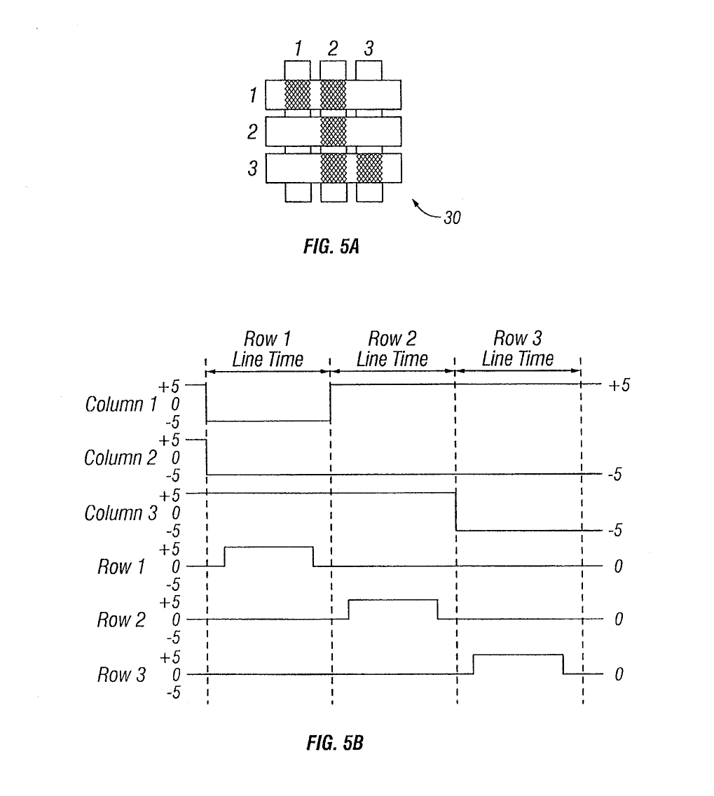

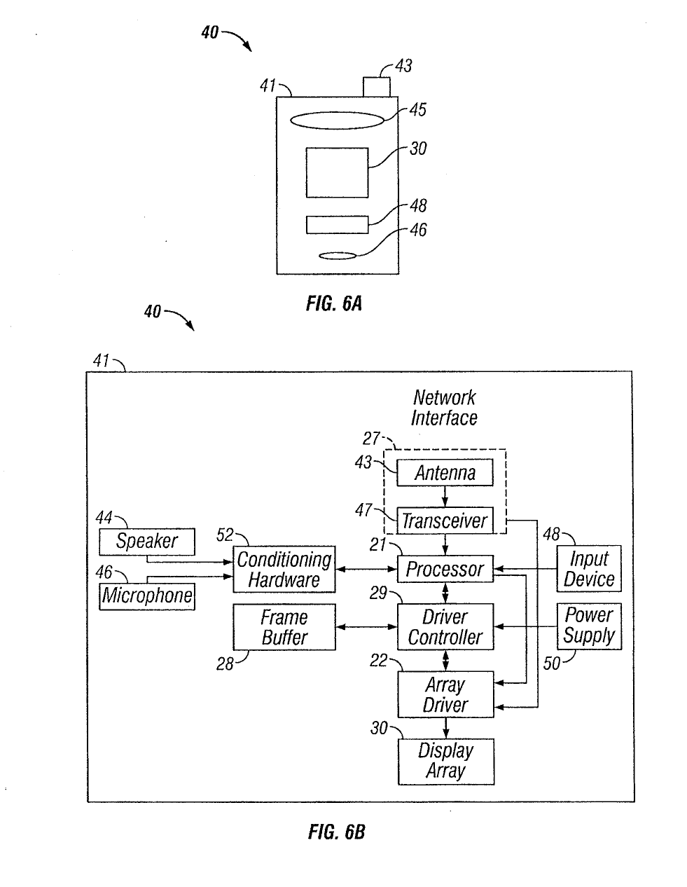

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts, respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

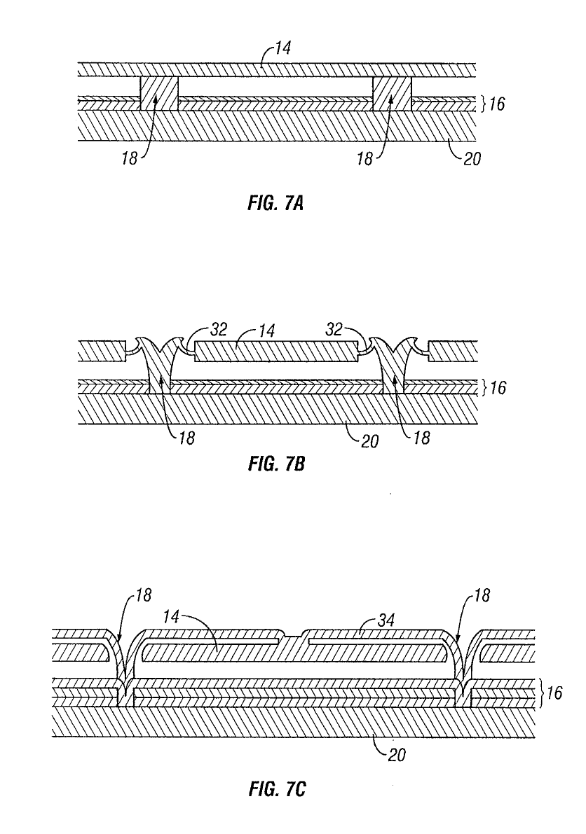

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28 and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment, the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, or a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell including a plastic solar cell, and solar-cell paint. In another embodiment, power supply 50 is configured to receive power from a wall outlet.

In some embodiments, control programmability resides, as described above, in a driver controller which can be located in several places in the electronic display system. In some embodiments, control programmability resides in the array driver 22. Those of skill in the art will recognize that the above-described optimizations may be implemented in any number of hardware and/or software components and in various configurations.

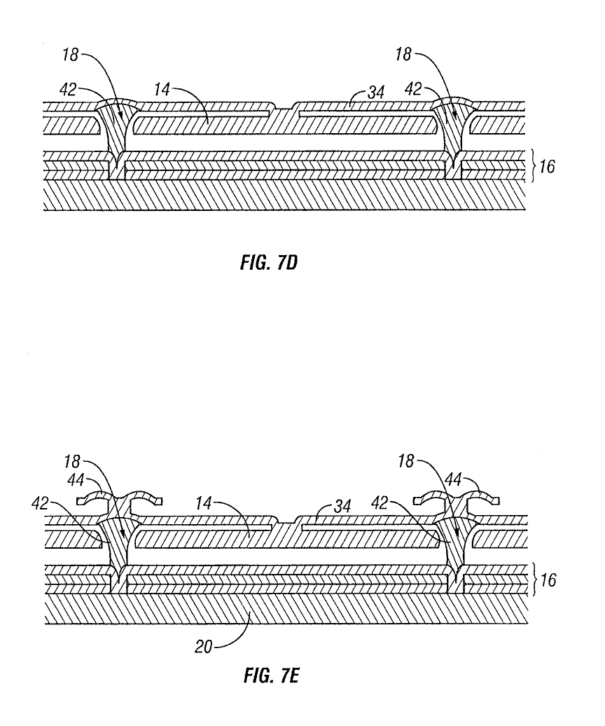

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C, as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As described above, the interferometric modulators are reflective and can rely on ambient lighting in daylight or well-lit environments. In addition, an internal source of illumination is often provided for illumination of interferometric modulators in dark ambient environments. In some embodiments, the illumination system for an interferometric modulator display or other spatial light modulator comprising a plurality of display elements comprises a light source, a light injection system, such as a light bar, and a light guide panel. The light injection system transforms light from a point source (e.g., a light emitting diode (LED)) into a line source. The light guide panel collects light from the light injection system at a narrow edge of the light guide panel and redirects it toward the display elements, preferably spreading light uniformly across the array of display elements. The light guide panel may comprise a light “turning” film to turn the light from in the light guide panel towards the array of display elements. The turning features may comprise a plurality of sloping portions that reflect light propagating along the length of the light guide panel to the display elements. The light reflects from the display elements and is transmitted back through the light guide panel to form an image for the viewer. However, depending upon where the light is incident on the surface features, the light will be refracted at different angles by the different sloping portions. As a result, light reflected from a single point on the array of display elements appears to originate from a plurality of different points, such that ghost images appear.

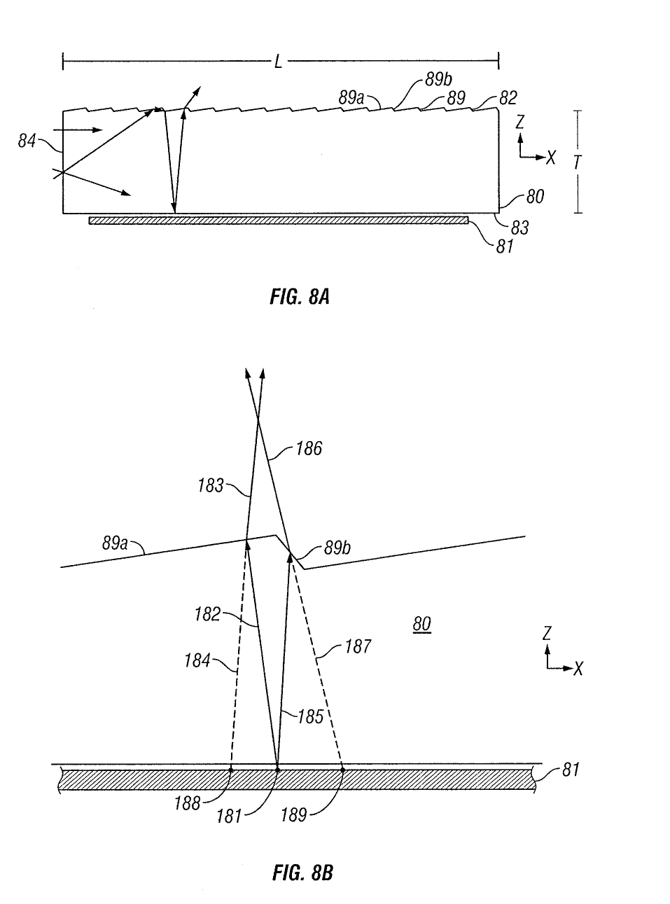

FIG. 8A is a cross-sectional view of a display device including an illumination system that comprises a light guide panel 80 and a plurality of display elements 81. The light guide panel 80 includes turning features 89 disposed thereon. The light injected into the light guide panel 80 propagates along the length of the light guide panel via total internal reflection. In order to provide illumination to the array of display elements, the light is turned through a large angle, usually between about seventy five to ninety degrees, such that it propagates through the thickness of the light guide panel and is transmitted to the active surface of the display elements 81.

The light turning features 89 may comprise a plurality of surface relief features located on the top, forward, or exposed, viewing side, 82 of the light guide panel 80. The surface features 89 include part of a thin turning film attached, for example, by lamination. Alternatively, the turning features may be fabricated directly on the top side 82 of the light guide panel 80, such as by embossing, injection molding, casting or other techniques. In certain embodiments, the surface features 89 comprise a plurality of prismatic microstructures arranged in a pattern extending along the length, L, of the light guide panel 80. The prismatic microstructures may comprise two or more turning facets 89a and 89b angled with respect to one another for reflecting the light incident on an air/facet interface, causing the light to be turned through a large angle. In certain embodiments, the surface features 89 comprise a plurality of repeating prismatic microstructures each comprising two adjacent, symmetrical facets. Alternatively, the surface features 89 may comprise a plurality of repeating prismatic microstructures each comprising two adjacent facets 89a, 89b having different angles of inclination with respect to the film or the length of the light guide panel 80. For example, in certain embodiments as shown in FIG. 8A, the plurality of pairs of adjacent facets 89a and 89b may comprise, one shallow, long facet 89a and a much shorter but more steeply inclined facet 89b.

The adjacent facets 89a and 89b, advantageously form angles with respect to one another such that light rays incident on the facets at an angle greater than the critical angle (as measured from normal to the facet), will undergo total internal reflection (TIR), and will be turned through a large angle, approximately 75° to 90°. For example, if light strikes the first, shallow facet 89a and then the second, steeper 89b facet sequentially as shown in FIG. 8A, total internal reflection occurs at both air/facet interfaces and the light is turned through a large angle to the array of display elements. The light following this path is then transmitted through the thickness, T, of the light guide 80 and output from the bottom/rearward side 83 on the adjacent display elements 81. Multiple internal reflections enhance mixing of light within the light guide 80 which assists in providing uniformity in light output across the display elements 81. In various embodiments, non-uniformity in the turning features 89 (e.g., height, depth, angle, density, etc.) across the length of the light guide panel 80 enhance uniformity in light output. For example, increase in the density of the turning features 89 with distance from the input edge 84 of the light guide panel 80 may cause the output efficiency to similarly increase across the light guide panel so as to counter attenuation in the light within the light guide panel.

When light rays reflected from the array of display elements 81 through the thickness of the light guide panel 80 exit the forward side 82 of the light guide panel through the adjacent facets 89a and 89b, the light is refracted at the light guide panel/air interface at the surface of the facets due to the difference in index of refraction between the light guide panel and air. The angle of refraction for light exiting the light guide panel 80 at the facets 89a and 89b is dependent on its angle of incidence at interface, according to Snell's law.

As discussed above and shown in FIG. 8B, in certain embodiments, the adjacent facets 89a and 89b are disposed at different angles of inclination with respect to the normal of the light guide panel. Accordingly, light rays 182 and 185 reflected from a single point 181 on the array of display elements 81 shown in FIG. 8B are incident upon the light guide/air interface at different angles of incidence, depending upon which facet 89a and 89b they strike. The light rays 182 and 185 are thus refracted at different angles depending upon their angle of incidence upon facets 89a and 89b. The resulting light rays 183 and 186 directed at different angles appear to be reflected from two different apparent reflection points 188 and 189 on the array of display elements rather than the original image point 181. This effect results in the creation of ghost images appearing slightly shifted relative to the true image reflected by the display elements 81. The steeper the facets 89a, 89b, the larger the lateral separation in X direction of the ghosts (188, 189) from the object (181). Also, the larger the fraction of lateral distance in the X direction subtended by a particular facet type, the more intense the ghost image associated with that facet, because of the larger number of rays captured by that facet. For example, in FIG. 8B the facet of type 89a subtends a larger lateral distance than the facet of type 89b, and thus the ghost image due to 89a will be more intense.

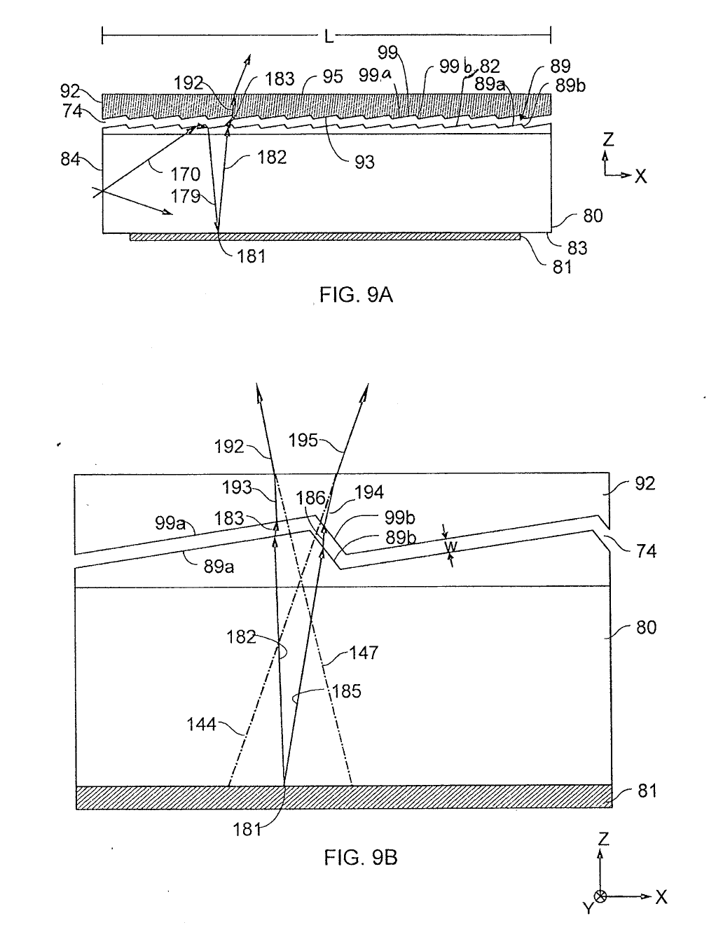

In certain embodiments, as shown in FIG. 9A, the ghost images may be reduced or eliminated by disposing a conjugate film 92 forward the front side 82 of the light guide panel 80. The conjugate film 92 refracts light rays emitted from the front surface 82 of light guide panel 80. The rays are refracted by the conjugate film 92 in a direction opposite to the refraction introduced by the front surface 82 of the light guide panel 80. The conjugate film 92 can thereby reverse, counter, or correct for the refraction resulting when the light rays are incident on the light guide panel/air interface.

The conjugate film 92 has a contoured transmissive surface 93 on the side disposed towards the light guide panel 80. In certain embodiments, the conjugate film 92 may have a forward, planar surface 95 opposite the contoured transmissive surface 93. The contoured transmissive surface 93 is comprised of a plurality of surface relief features 99 extending across the length, L, of the conjugate film 92. In certain embodiments, the surface relief features 99 have a substantially complimentary shape to the plurality of surface relief features 89 extending across the length, L, of the light guide panel 80. For example, in some embodiments, the plurality of surface features 99 on the conjugate film 92 may comprise a plurality of protrusions and the surface relief features 89 on the light guide panel 80 may comprise a plurality of corresponding indentations extending across the length, L, thereof. (In some embodiments, the plurality of surface features 99 on the conjugate film 92 comprises a plurality of indentations and the surface relief features 89 on the light guide panel 80 comprises a plurality of corresponding protrusions. In some embodiments one or both of the conjugate film 92 and the light guide panel 80 comprise both protrusions and indentations.) The protrusions (or indentations) may be formed of adjacent sloping side walls disposed at substantially the same angle with respect to one another to form symmetric protrusions (or indentations). Alternatively the adjacent sloping sidewalls may be disposed at different angles of inclination with respect to one another such that the protrusions (or indentations) are asymmetrical. In certain embodiments, the sloping sidewalls may comprise substantially planar surfaces. In other embodiments, the sloping sidewalls may comprise faceted surfaces. In some embodiments, the sloping sidewalls may be curved.

In certain embodiments, the shape and size of the corresponding surface features 99 (protrusions or indentations) on the conjugate film 92 may be dictated by the shape necessary in the surface relief features 89 on the light guide 80, which effectively and efficiently turn light injected through the side edge 84 of the light guide panel 80 toward the array of display elements 81. For example, as shown in FIG. 9A, the facets forming the surface relief features 89 in the light guide panel 80, may include a facet 89a tilted about 2 degrees from horizontal, and the facet 89b tilted at about 45 degrees. The surface features 99 on conjugate film 92 may be formed by facets 99a and 99b that are equal and opposite the facets 89a and 89b on the light guide panel 80. Accordingly in the above mentioned embodiment, a facet 99a may likewise be tilted at about 2 degrees from horizontal and a facet 99b may likewise be tilted at about 45 degrees.

In certain embodiments, different shapes and configurations may be employed. Additionally, the shapes and/or sizes of the surface relief features 89 and 99 may vary across the length, L of the light guide 80 and conjugate film 92 respectively. However, in certain embodiment regardless of the shape or configuration, the corresponding facets of the light guide 80 and the conjugate film 92 are substantially equal and opposite. In some embodiments, some difference in shape, size, spacing, etc. may be included.

The substantially complimentary conjugate film 92, as well as the surface relief features on the light guide 80 may be fabricated by embossing, UV casting, a roll-to-roll process or any other suitable process known in the arts. In various embodiments, the conjugate film 92 and the surface relief features on the light guide 80 are made by the same tool or die. In one example, the same master may form the forward surface 82 of the light guide panel 80 and the matching rearward surface 93 of the conjugate film 92. The surface 93 of the conjugate film 92 is simply flipped (e.g., about an axis parallel to the x axis) and rotated (e.g. rotated about an axis parallel to the z axis) with respect to the surface of the light guide panel 80. Alternatively, the surface 93 of the conjugate film 92 may be flipped about an axis parallel to the Y axis. Alternatively, in certain embodiments, for example, when the size and shape of the surface relief features increases or decreases across the length, L, of the film, separate, complimentary tools may be used for creating for the surface relief features 89 on the light guide 80 and the surface relief features 99 on the conjugate film 92.

The surface relief features 99 on the conjugate film 92 are further aligned with the surface relief features 89 on the light guide panel 80 such that the plurality of protrusions on the contoured surface 93 of the conjugate film 92 correspond to and can therefore extend into the plurality of indentations formed by the forward surface 82 on the light guide panel 80. For example, in some embodiments, the apices of the plurality of protrusions in the surface relief features 99 on the conjugate film 92 are approximately aligned with the nadirs of the plurality of indentations in the surface relief features 89 on the light guide 80 or vice versa. In other embodiments, the start or edges of the surface relief features 99 on the conjugate film 92 may be aligned with the start or edges of the surface relief features 89 on the light guide panel 80. Alternatively, the alignment can be characterized as one or more portions of the surface relief features 99 of the conjugate film 92 being approximately aligned with one or more corresponding portions of the surface relief features 89 of the light guide panel 80.

In some embodiments, the conjugate film 92 has an index of refraction substantially the same as the index of refraction of the light guide panel 80. In certain embodiments, a small air gap 74 is maintained between the conjugate film 92 and the light guide 80 to maintain the air/light guide panel interface that produces total internal reflection of light propagating through the length, L, through the light guide panel 80. Alternatively, a medium having a lower index of refraction than the light guide panel 80 and the conjugate film 92 may be disposed between the light guide panel 80 and the conjugate film 92 to ensure that the light propagating through the length of the light guide 80 will be totally internally reflected at the interface between the light guide panel and the medium. Such a medium may be gas, liquid, or solid.

In certain embodiments, the index of refraction of the light guide panel 80 and the conjugate film 92 may be different. In such cases, the shape of the surface features 89 on the light guide panel 80 and the surface features 99 on the conjugate film need not be identical or complimentary. The index and shapes, however, can be selected such that the refraction caused by the surface features 99 in the conjugate film 92 counters, reduces, or cancels out the refraction caused by the surface features 89 in the light guide panel 80. In such embodiments, ghosting can still be reduced, minimized, or eliminated.

In use, as shown in FIG. 9A, light 170 injected into the light guide panel 80 will be totally internally reflected when it sequentially strikes the light guide panel/air interfaces formed by facets 89a and 89b at an oblique or grazing angle, e.g., greater than the critical angle. The light 179 is then turned through a large angle, between about 75-90 degrees and output onto the plurality of display elements 81. The plurality of display elements 81 reflects the light 182 through the thickness of the light guide panel 80. The light 182 then strikes the light guide panel/air interface where it is refracted an amount depending upon the angle of incidence at which the light strikes the surface relief feature 89 of the light guide panel 80. The refracted light ray 183 is then transmitted though the conjugate film 92 disposed forward of the light guide panel 80. Here, the light ray 183 is refracted a second time at the air/conjugate film interface. Again, the amount of refraction depends upon the angle of incidence at which light ray 183 strikes the surface relief features 99 of the conjugate film 92. Thus, if the conjugate film 92 has a surface relief 99 equal and opposite to the surface relief 89 on the light guide panel 80, the refraction at the conjugate film/air interface will reverse the refraction resulting from the light traveling through the light guide panel/air interface. Ghost images can thereby be reduced in this manner.

For example, as shown in FIG. 9B, light rays 182 and 185 are reflected from the same reflection point 181 on the plurality of display elements 81. Light rays 182 and 185 are then transmitted through the thickness, T, of the light guide panel 80. Light rays 182 and 185 were reflected at different angles, with respect to normal, from the plurality of display elements 81. Accordingly, light ray 182 is incident on a long, shallow facet 89a at an angle of inclination θᵢ₁ with respect to the facet 89. Light ray 182 is refracted through the facet 89a according to Snell's law,

n₁ sin θᵢ₁=n₂ sin θᵣ₁

where n₁ is the index of refraction of the light guide 80, n₂ is the index of refraction of the air gap 74, θᵢ₁ is the angle of incidence of ray 182, and θᵣ₁ is measured between the refracted ray 183 and the normal to the facet 89a. As discussed above with respect to FIG. 8B, the refracted ray 183 would then appear to be coming from an apparent source 188 instead of the true image reflection point 181 on the array of display elements 81. Here, however, the ray 183 is refracted a second time at the air/conjugate film interface when it is incident upon facet 99a of the conjugate film 92. Since the conjugate film 92 and the light guide panel 80 are complimentary, the facet 99a of the conjugate film 92 is substantially parallel to the facet 89a of the light guide panel 80. Likewise, the angle of incidence θᵢ₂ at which the light ray 183 strikes facet 99a is the same as the angle of refraction θᵣ₁ of light ray 183. According to Snell's law, therefore, the ray 193 refracted by the conjugate film 92 will have an angle of refraction θᵣ₂ which is equal to θᵢ₁, assuming that the index of refraction is the same for the light guide panel 80 and the conjugate film 92 (e.g., n₁=n₂). As a result of this process, light ray 193 will be parallel to light ray 182.

Because of the width, W, of the air gap 74, the refracted light ray 183 travels in a lateral direction away from original light ray 182 before striking facet 99a and being refracted along its original path. Thus, light ray 193 will be parallel to light ray 182 but slightly shifted laterally. Accordingly, in certain embodiments, the width, W, of the air gap 74 is selected to reduce or minimize the lateral shift of light rays refracted through the air gap, thereby reducing or minimizing the lateral shift. At the same time, in various embodiments, the air gap 74 provides sufficient distance between the light guide panel 80 and the conjugate film 92 to permit light rays guided through the light guide panel 80 to be totally internally reflected at the boundary of the light guide 80. In some embodiments, the width of the gap can be less than half of the prism depth. In some other embodiments, the width of the gap can be kept as close to zero as possible while still allowing air separation. For example, in certain embodiments, the width, W, of the air gap may be between approximately 0.75 microns and approximately 5 microns. In certain other embodiments, the width W of the air gap may lie outside the range specified, for example the width W of the air gap may be less than 0.75 microns and greater than 5 microns. As described above, the gap 74 may comprise other mediums and may be gas, liquid, or solid.

In FIG. 9B light ray 185, on the other hand, is incident on a short, steep facet 89b at an angle of inclination θ_{i1′} with respect to the normal to the facet 89b. As shown in FIG. 8B, light ray 185 likewise undergoes refraction with respect to the facet 89b according to Snell's law such that refracted ray 186 would then appear to be coming from apparent image point 189. Here, because the angle of incidence θ_{i1′} with respect to the normal to the facet 89b is much larger than the angle of incidence θᵢ₁ respect to the normal to the facet 89a, the light ray 186 is refracted over a greater angle and thus appears to be coming from an apparent source 189 farther from the actual image reflection point 181 on the array of display elements. However, as shown in FIG. 9B, as with light ray 183, the ray 186 is refracted a second time at the air/conjugate film interface when it is incident upon facet 99b of the conjugate film 92. Since the conjugate film 92 and the light guide panel 80 are complimentary, the facet 99b of the conjugate film 92 is substantially parallel to the facet 89b of the light guide panel 80. Accordingly, the angle of incidence θ_{i2′} at which the light ray 186 strikes facet 99b is the same as the angle of refraction θ_{r1′} of light ray 186. Thus, the resulting ray 194 will have an angle of refraction θ_{r2′}, which is equal to θ_{i1′}. This conclusion presumes that the index of refraction is substantially the same for the light guide panel 80 and the conjugate film 92 (e.g., n₁=n₂). Accordingly, light ray 194 will be parallel to light ray 185. Here again, because of the width, W, of the air gap 74, the refracted light ray 186 traveled in a lateral direction away from original light ray 185 before striking facet 99b. Likewise, light ray 194 will be parallel to light ray 185 but slightly laterally shifted.

Rays 193, 194 are refracted again upon exiting the conjugate film and entering air above the conjugate film 92. Accordingly, these rays may be non-parallel to rays 182, 185 within the light guide panel 80. In general, however, both the emitted light rays 192 and 195 will appear to be coming from substantially the originally image point 181 from which light rays 182 and 185 were reflected despite the fact that light ray 182 was refracted by a shallow facet 89a and light ray 185 was refracted by a steep facet 89b. In certain embodiments, at least the ghosting is reduced by the presence of the conjugate film.

In certain embodiments, the light guide panel 80 and conjugate film 92 described above may be advantageously used in conjunction with other illumination apparatus features to direct light onto the plurality of display elements 81.

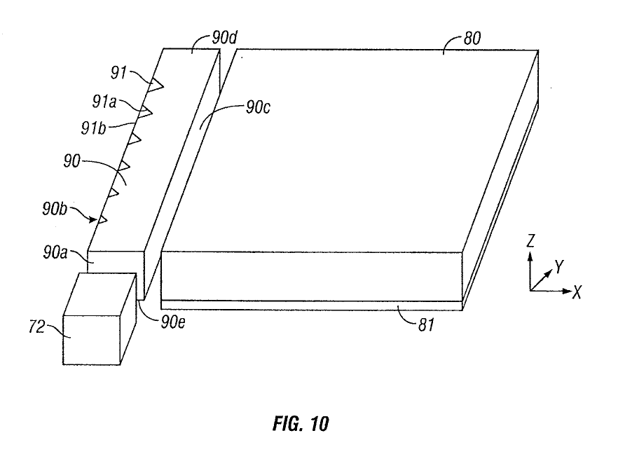

FIG. 10 illustrates a display device comprising an illumination apparatus that comprises a light bar 90 coupled to the edge of the light guide panel 80. The light bar 90 has a first end 90a for receiving light from a light emitter 72, such as a light emitting diode (LED), although other light sources may also be used. The light bar 90 comprises substantially optically transmissive material that supports propagation of light along the length of the light bar 90. Light injected into the light bar 90 is propagated along the length of the bar. The light is guided therein, for example, via total internal reflection at sidewalls thereof, which form interfaces with air or some other surrounding fluid or solid medium.

Turning microstructure 91 is located on at least one side of the light bar 90, for example, the side 90b that is substantially opposite the light guide panel 80. The turning microstructure 91 is configured to turn at least a substantial portion of the light incident on that side 90b of the light bar 90 and to direct that portion of light out of the light bar 90 (e.g., out side 90c) into the light guide panel 80. The turning microstructure 91 of the light bar 90 comprises a plurality of turning features 91 having facets 91a (which may be referred to as faceted turning features or faceted features), as can be seen in FIG. 8B. The features 91 shown in FIG. 10 are schematic and exaggerated in size and spacing there between.

The facets 91a or sloping surfaces are configured to direct or scatter light out of the light bar 90 towards the light guide panel 80. Light may, for example, reflect by total internal reflection from a portion 91b of the sidewall of the light bar 90 parallel to the length of the light bar and to one of the sloping surfaces 91a. This light may reflect from the sloping surface 91a in a direction toward the light guide panel 80. In the embodiment illustrated in FIG. 10, the turning microstructure 91 comprises a plurality of triangular grooves having substantially triangular cross-sections, although other shapes are also possible.

The shape and orientation of the turning features 91 will affect the distribution of light exiting the light bar 90 and entering the light guide panel 80. In addition, the size and density of the turning features across the length of the light guide may affect the distribution of light exiting the light bar 90. For example, the turning microstructure 91 may have a size that remains substantially constant with distance, d, from the light source 72 or on average, increases with distance, d, from the light source 72. Alternatively, in certain embodiments, the turning microstructure 91 may have a density, ρ, of turning features that remains substantially the same with distance, d, from the light source 72 or on average, increases with distance, d, from the light source 72.

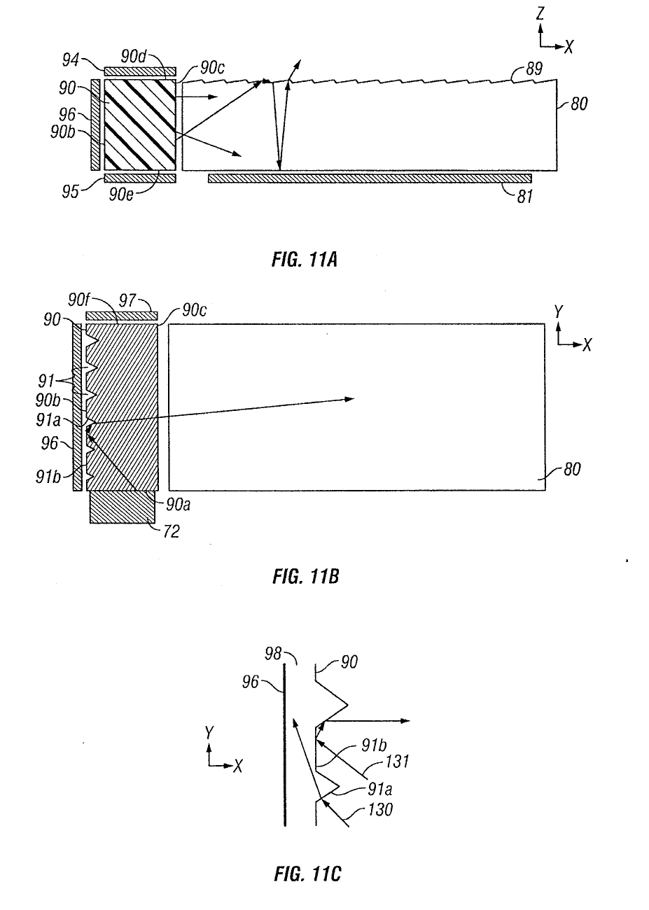

As illustrated in FIGS. 11A and 11B, the illumination apparatus may additionally comprises one or more reflectors or reflecting portions 94, 95, 96, 97 disposed with respect to the sides (top 90d, bottom 90e, left 90b, and/or end 90f) of the light bar 90. In various embodiments, the reflective surfaces 94, 95, 96, and 97 may comprises planar reflectors although other shapes are possible. The reflective surfaces 94, 95, 96, and 97 are disposed with respect to the light bar 90 to direct light that would otherwise be transmitted out of the top 90d, bottom 90e, left 90b, and end 90f back into the light bar 90. In particular, the reflector 97 directs the light propagating through the light bar 90 that would be directed out the back end (or second end) 90f of the light bar 90 back towards the light source 72. Similarly, reflectors 94 and 95 direct the light propagating through the light bar 90 that would be directed out the top 90d or the bottom 90e of the light bar 90 back into the light bar 90. This light propagates within the light bar 90 where it may be directed towards the light guide panel 80. In some cases, the light redirected back into the light bar 90 is ultimately incident on the turning microstructure 91 and is thereby directed to the light guide panel 80.

FIG. 11C illustrates rays propagating through the first side 90a of the light bar 90 to the side reflector 96. The reflector 96 should be close enough that light transmitted through the light bar 90, for example, the ray 130 that hits a first surface 91a of the faceted turning feature 91 at an angle such that it is not totally internally reflected, is reflected back into the light bar 90. However, the reflector 96 should also be spaced from the light bar 90 such that it does not interfere with the total internal reflection of the light bar 90. For example, the reflector 96 may be separated from the light bar 90 by a gap 98. FIG. 11D illustrates other embodiments, wherein the turning features comprises diffractive features 137 rather than prismatic features.

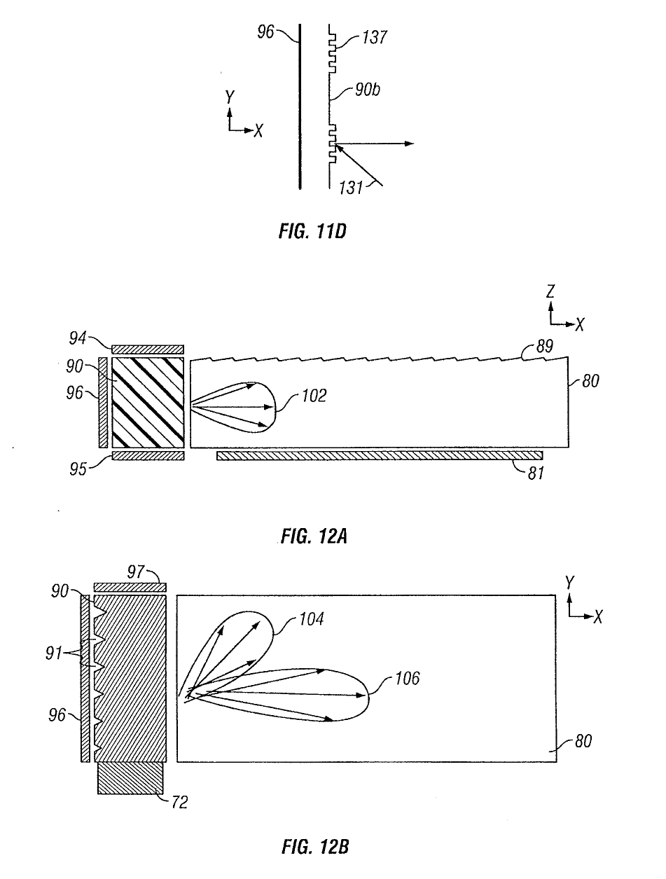

In various embodiments, a substantial portion of the light output from the light bar 90 is reduced or restricted in its angular distribution and similarly the light injected into the light guide panel 80 is also reduced or restricted in its angular distribution. As schematically illustrated in FIGS. 12A and 12B, for the embodiments including the planar reflectors 94, 95, 96, 97, the angular distribution of light propagating into the light guide panel 80 consists of two primary lobes 104, 106. In FIG. 12B, the lobe 106 propagates from the light bar 90 generally perpendicularly to the length of the light bar and is generally reduced or restricted in angular distribution. In contrast, the lobe 104 propagates from the light bar 90 at an angle less than 90° from the length of the light bar. This lobe 104 is located on a side farther from the light source 72 and closer to the far end 91f of the light bar 90. In FIG. 12A, the lobe 102 is a side view of the lobes 104, 106 of FIG. 12B and is generally symmetrical.

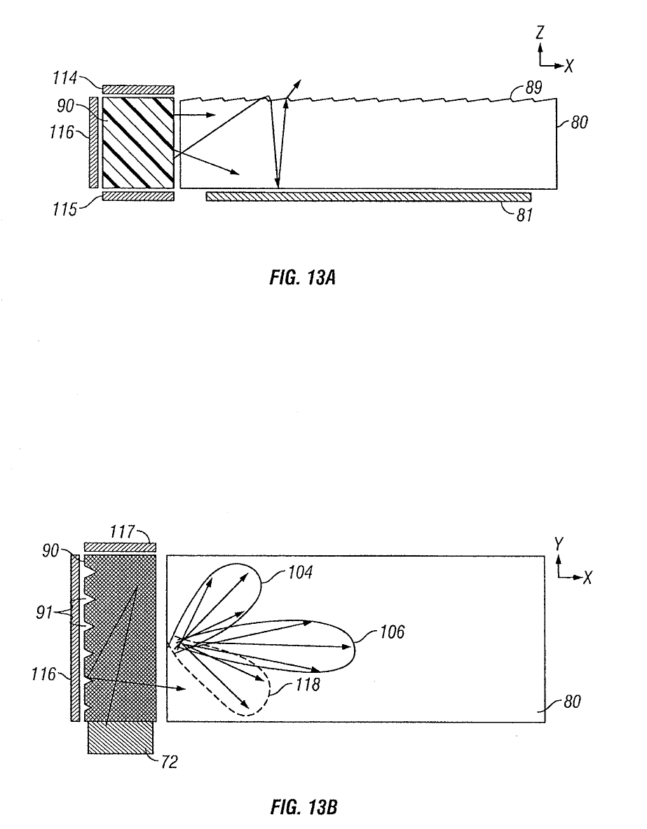

FIGS. 13A and 13B illustrate an embodiment in which retro reflectors 114, 115, are used in place of the reflectors 94, 95. The retro reflectors 114, 115 reflect light in such a way that the light is returned in the direction from which it came. For example, retro reflectors 114, 115 disposed with respect to the top and bottom 90d, 90e surfaces of the light bar 90 generates a lobe of light 118 that propagates from the light bar at an angle less than 90° from the length of the light bar on the same side of the normal to the length as the light emitter 72 as shown in FIG. 13B. A more symmetrical light distribution is ejected from the light bar 90 thereby helping to balance the amount of light directed into the light guide panel 80 and therefore into the display elements 81. In certain embodiments, one or more of the reflectors 116, 117 also comprise retro reflectors.

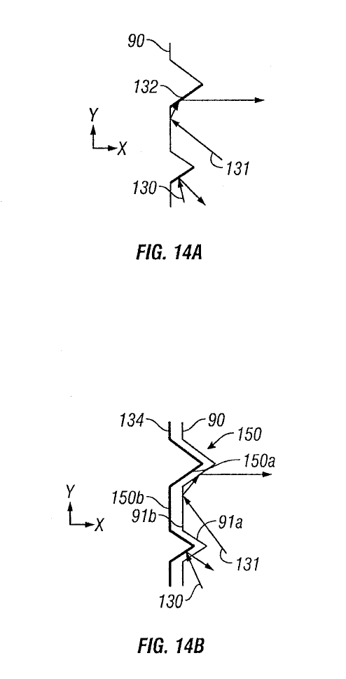

Other configurations are also possible. FIG. 14A illustrates an embodiment in which sloping surface portions or facets 132 of the turning features comprise reflective material, such as metal (e.g., aluminum) which prevents rays 130 from passing through the sloping surface portion 132. The ray 130 reflects back into the light bar 90 rather than being transmitted therethrough. Alternatively, as illustrated in FIG. 14B, a contoured reflector 134 may be positioned proximal to the first side 90b of the light bar 90. The contoured reflector 134 includes a plurality of protrusions 150 having sloping surfaces 150a separated by non-sloping portions 150b. The protrusions 150 of the reflective surface 134 can penetrate into indentations 91, e.g., grooves, forming the turning features 91 of the light bar 90. In this manner, the reflective surface of the contoured reflector 134 can come close to the turning film. However, a small air gap or gap filled with another medium, can separate the contoured reflector 134 from the turning film.

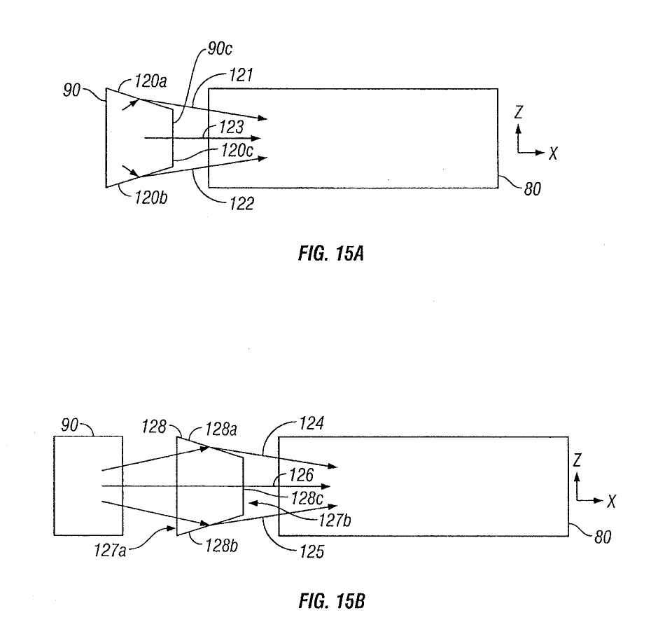

FIG. 15A illustrates an embodiment in which the light bar 90 has a tapered cross section orthogonal to the length of the light bar. This tapered cross section provides for increased light collimation. For example, the configuration of the second side 90c, including first and second sloping portions 120a, 120b that slope toward a central portion 120c, refracts light so as to increase collimation of light directed into the light guide panel 80. Although not depicted, the tapered light bar 90 may comprise the turning microstructure 91 as described above. For example, the left side 90b of the light bar 90 may comprise turning microstructure 91.

In some embodiments, a substantially transmissive elongate optical coupling member or optical coupler 128 is disposed between the light bar 90 and the light guide panel 80 as illustrated in FIG. 15B. In the embodiment shown, the light bar 90 may have a substantially rectangular cross-section. The elongate optical coupling member 128, however, has a cross-section that is tapered from a first side 127a closer to the light bar 90 to a second side 127b closer to the light guide panel 80. This taper increases the collimation of light from the light bar 90 that is injected into the light guide panel 80.

A wide variety of variations are possible. Films, layers, components, and/or elements may be added, removed, or rearranged. Additionally, processing steps may be added, removed, or reordered. Also, although the terms “film” and “layer” have been used herein, such terms as used herein may include film stacks and multilayers. Such film stacks and multilayers may be adhered to other structures using adhesive or may be formed on other structures using deposition or in other manners.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An illumination apparatus comprising:
a light guide panel having a first end for receiving light from a light source, said light guide panel comprising material that supports propagation of said light along the length of the light guide panel;
a plurality of indentations disposed on a first side of the light guide panel, the indentations configured to turn at least a substantial portion of the light incident on the first side and to direct said portion of light out a second, opposite side of the light guide panel, said indentations having sloping sidewalls that reflect light by total internal reflection out said second side of the light guide panel; and
at least one contoured transmissive surface comprising a plurality of protruding surface portions having substantially complimentary shape to corresponding of said plurality of indentations in said light guide panel, said at least one contoured transmissive surface separated from said light guide panel by a gap.

2. The illumination apparatus of claim 1, wherein the plurality of indentations comprises a plurality of faceted features formed in said light guide panel.

3. The illumination apparatus of claim 1, wherein the plurality of indentations comprises a plurality of grooves formed in said light guide panel.

4. The illumination apparatus of claim 1, wherein said light guide panel comprises a turning film and said plurality of indentations are included in said turning film.

5. The illumination apparatus of claim 1, wherein said sloping sidewalls comprise substantially planar surfaces.

6. The illumination apparatus of claim 5, wherein said sloping sidewalls are configured such that adjacent sloping sidewalls form substantially triangular indentions.

7. The illumination apparatus of claim 6, wherein said adjacent sloping sidewalls have different angles of inclination with respect to said light guide panel.

8. The illumination apparatus of claim 6, wherein said plurality of protruding surface portions of said contoured transmissive surface comprise substantially planar sloping sides.

9. The illumination apparatus of claim 8, wherein adjacent planar sloping sides form substantially triangular protruding surface portions in said contoured transmissive surface.

10. The illumination apparatus of claim 8, wherein the angle of inclination between adjacent sloping sidewalls of said plurality of indentations is substantially the same as the angle of inclination between adjacent sloping sides of said plurality of protruding portions.

11. The illumination apparatus of claim 1, wherein said protruding surface portions of said contoured transmissive surface extend into said plurality of indentations.

12. The illumination apparatus of claim 1, wherein said protruding surface portions of said contoured transmissive surface are substantially aligned with said plurality of indentations disposed on said light guide panel.

13. The illumination apparatus of claim 1, wherein said at least one contoured transmissive surface comprises a film.

14. The illumination apparatus of claim 1, wherein the gap comprises an air gap.

15. The illumination apparatus of claim 1, wherein the gap is filled with gas.

16. The illumination apparatus of claim 1, wherein the gap is filled with a material having an index of refraction different from said light guide panel and said contoured transmissive surface.

17. The illumination apparatus of claim 1, wherein the index of refraction of said light guide panel is substantially the same as the index of refraction of said contoured transmissive surface.

18. The illumination apparatus of claim 1, wherein the gap between said plurality of indentations and said contoured transmissive surface is less than approximately 5 microns.

19. The illumination apparatus of claim 1, wherein the light guide panel is disposed with respect to a plurality of spatial light modulators such that light ejected from said second side of said light guide panel illuminates the plurality of spatial light modulators.

20. The illumination apparatus of claim 19, wherein the plurality of spatial light modulators comprises MEMS devices.

21. The illumination apparatus of claim 19, wherein the spatial light modulator comprises a first partially transmissive reflector and a second movable reflector separated by a gap distance, said second movable reflector movable with respect to said first partially transmissive reflector so as to alter said gap distance.

22. The illumination apparatus of claim 19, wherein the plurality of spatial light modulators comprises an array of interferometric modulators.

23. The illumination apparatus of claim 1 further comprising:
a light bar disposed with respect to said light guide panel, wherein the light bar has a first end for receiving light from the light source, said light bar comprising material that supports propagation of said light along the length of the light bar;
turning microstructure disposed on a first side of the light bar, the turning microstructure configured to turn at least a substantial portion of light incident on the first side and to direct the portion of the light out a second opposite side of the light bar; and
at least one substantially reflective surface disposed with respect to said light bar to reflect light escaping from the light bar through a portion of the light bar other than said second side back into said light bar.

24. The illumination apparatus of claim 23, wherein the turning microstructure comprises faceted features in a film on said first side of said light bar.

25. The illumination apparatus of claim 23, wherein the turning microstructure comprises a plurality of grooves.

26. The illumination apparatus of claim 25, wherein the turning microstructure comprises a plurality of triangular grooves having substantially triangular cross-sections.

27. The illumination apparatus of claim 23, wherein the turning microstructure comprises a plurality of diffractive features.

28. The illumination apparatus of claim 23, wherein the at least one reflective surface is disposed with respect to said first side of the light bar to receive light transmitted therethrough.

29. The illumination apparatus of claim 23, wherein the light bar further comprises a second end and the at least one reflective surface is disposed with respect to the second end of the light bar to receive light transmitted therethrough.

30. The illumination apparatus of claim 23, wherein the light bar further comprises a top side and an opposite bottom side, and the at least one reflective surface is disposed with respect to said top side of the light bar to receive light transmitted therethrough.

31. The illumination apparatus of claim 23, wherein the light bar further comprises a top side and an opposite bottom side, and the at least one reflective surface is disposed with respect to said bottom side of the light bar to receive light transmitted there through.

32. The illumination apparatus of claim 23, wherein the light bar further comprises a top side and an opposite bottom side, and the at least one reflective surface comprises reflective surfaces disposed with respect to said first side, said top side, and said bottom side of the light bar to receive light transmitted therethrough.

33. The illumination apparatus of claim 32, wherein the light bar further comprises a second end and the at least one reflective surface is disposed with respect to said second end of the light bar to receive light transmitted therethrough.

34. The illumination apparatus of claim 23, wherein the light bar further comprises a top side and an opposite bottom side, and the at least one reflective surface comprises reflective surfaces disposed with respect to said first side and said top side.

35. The illumination apparatus of claim 23, wherein the reflective surface comprises a reflective sheet.

36. The illumination apparatus of claim 35, the reflective sheet comprises metal.

37. The illumination apparatus of claim 23, wherein the reflective surface is separated from the light bar by a gap.

38. The illumination apparatus of claim 23, wherein the at least one reflective surface comprises a retro reflector.

39. The illumination apparatus of claim 23, wherein the at least one reflective surface comprises a plurality of retro reflectors.

40. The illumination apparatus of claim 23, wherein the at least one reflective surface comprises a reflective film disposed on said light bar.

41. The illumination apparatus of claim 40, said reflective film comprises metal film or dielectric multilayer film.

42. The illumination apparatus of claim 23, wherein said second surface of light bar is tapered.

43. The illumination apparatus of claim 42, wherein the second surface includes at least one planar sloping portion.

44. The illumination apparatus of claim 42, wherein the second surface includes at least one curved portion.

45. The illumination apparatus of claim 42, wherein the second surface is multifaceted.

46. The illumination apparatus of claim 42, wherein the second surface includes first and second sloping portions that slope toward a central portion.

47. The illumination apparatus of claim 46, wherein the central portion is substantially planar.

48. The illumination apparatus of claim 46, wherein the first and second sloping portions are substantially planar.

49. The illumination apparatus of claim 23, wherein the light bar has a thickness that is reduced towards said light guide panel.

50. An method of manufacturing an illumination apparatus comprising:
providing a light guide panel having a first end for receiving light from a light source, said light guide panel comprising material that supports propagation of said light along the length of the light guide panel;
disposing a plurality of indentations on a first side of the light guide panel, the indentations configured to turn at least a substantial portion of the light incident on the first side and to direct said portion of light out a second, opposite side of the light guide panel, said indentations having sloping sidewalls that reflect light by total internal reflection out said second side of the light guide panel; and
including at least one contoured transmissive surface comprising a plurality of protruding surface portions having substantially complimentary shape to corresponding of said plurality of indentations in said light guide panel, said at least one contoured transmissive surface separated from said light guide panel by a gap.

51. An illumination apparatus comprising:
means for guiding light having a means for receiving light from a means for emitting light, said light guiding means comprising means for supporting propagation of said light along the length of the light guiding means;
means for turning at least a substantial portion of light incident on a first side of said light guiding means, the light turning means configured to direct said portion of light out a second, opposite side of the light guiding means, said light turning means having means for reflecting light by total internal reflection out said second side of the light guiding means; and
means for transmitting light comprising means for providing a complimentary shape to corresponding of said light turning means in said light guiding means, said light transmitting means separated from said light guide means by means for separating.

52. The illumination apparatus of claim 51, wherein said light guiding means comprises a light guide panel.

53. The illumination apparatus of claim 51, wherein said light receiving means comprises a first end of said light guiding means.

54. The illumination apparatus of claim 51, wherein said light emitting means comprises a light source.

55. The illumination apparatus of claim 51, wherein said light propagation supporting means comprises a material that supports propagation of said light along the length of the light guiding means.

56. The illumination apparatus of claim 51, wherein said light turning means comprises a plurality of indentations disposed on a first side of the light guiding means.

57. The illumination apparatus of claim 51, wherein said light reflecting means comprises sloping sidewalls.

58. The illumination apparatus of claim 51, wherein said light transmission means comprises at least one contoured transmissive surface.

59. The illumination apparatus of claim 51, wherein complementary shape providing means comprises plurality of protruding surface portions.

60. The illumination apparatus of claim 51, wherein said separating means comprises a gap.
